(19) United States
(12) Patent Application Publication
(10) Pub. No.: US 2011/0031729 A1
(43) Pub. Date: Feb. 10, 2011

(54) METHOD AND DEVICE FOR MAKING AN ALBUM

(75) Inventors: Iisakki Huotari, Espoo (FI); Henri Huotari, Espoo (FI); Markku Siikamäki, Espoo (FI); Peter Archer, Helsinki (FI); Lauri Huotari, Espoo (FI)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: Maping Kommandiittiythio L. Huotari, Espoo (FI)

(21) Appl. No.: 12/676,681

(22) PCT Filed: Sep. 4, 2008
(86) PCT No.: PCT/FI2008/050489

§ 371 Date: Oct. 25, 2010

(30) Foreign Application Priority Data
Sep. 7, 2007 (FI) 20070668

(51) Int. Cl. B42D 3/00; B42C 9/00

(52) U.S. Cl. 281/29; 412/9

(57) ABSTRACT

The invention relates to a method and device for making an album, particularly from folded photograph sheets (3) and cover (2, 5) and divider sheets (4), which are glued into the form of an album. At least the photograph sheets (3) and the divider sheets (4) are positioned for gluing by using positioning means (e.g. 11-15, 20), the position of which relative to the glued piece can be moved away from the location of the glued piece.

The present invention relates to a method and a device, with the aid of which it is possible to make albums, for example from photographs, easily.

Making such albums, for example from photographs, in which there is a folded photograph attached to sturdy board, in such a way that it is precisely the folded spine of the photograph that acts as a factor connecting the covers, has mostly required handwork. This means gluing the photographs to the board using either a spreadable glue, or an adhesive surface that is covered by a protective sheet and is exposed for gluing. Both the board sheets and the photograph sheets are positioned by hand and the final result is cut to a suitable model. When working as described above, the result is not always very good, gluing can take place at a slight slant, or otherwise in the wrong place. As relatively large image sheets are often involved, the economic losses are considerable.

The present invention is intended to create a method and device, with the aid of which the result will always be of a reasonable quality. In addition, the result can be achieved quite quickly, but in any event always in a guaranteed manner.

The above and other benefits and advantages of the present invention are achieved in the manner described as characteristic in the accompanying Claims.

In the following, the invention is described with reference to drawing, which shown well-regarded embodiments of the invention.

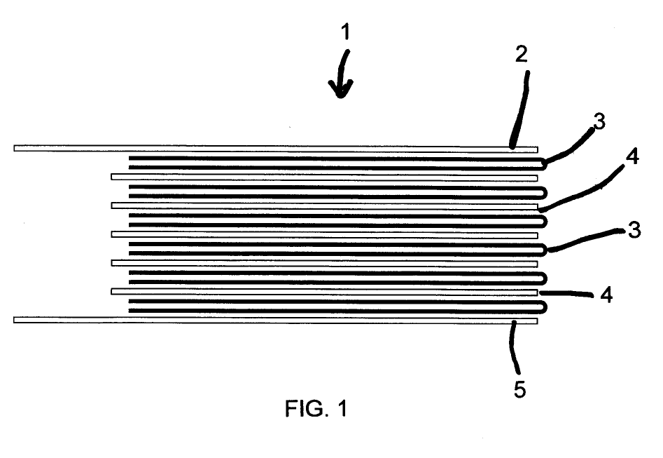

FIG. 1 shows the end result of the method according to the invention;

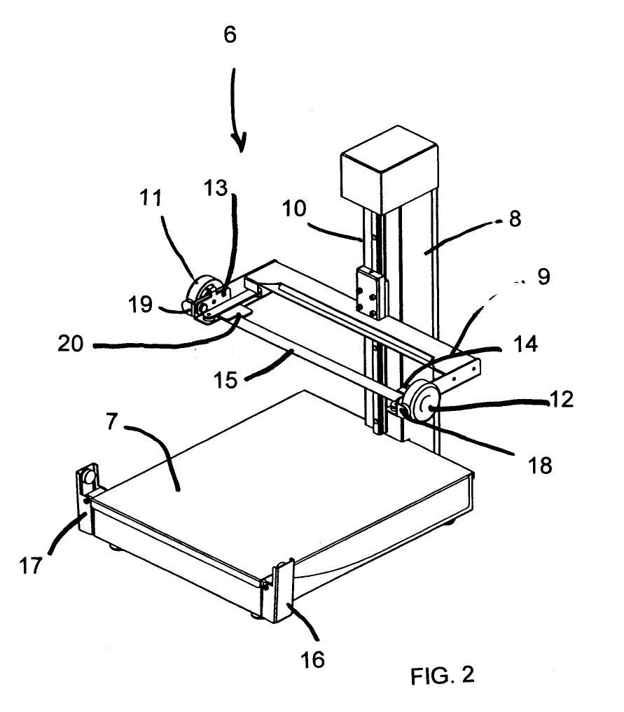

FIG. 2 shows a general axonometric view of manually operated version of the invention;

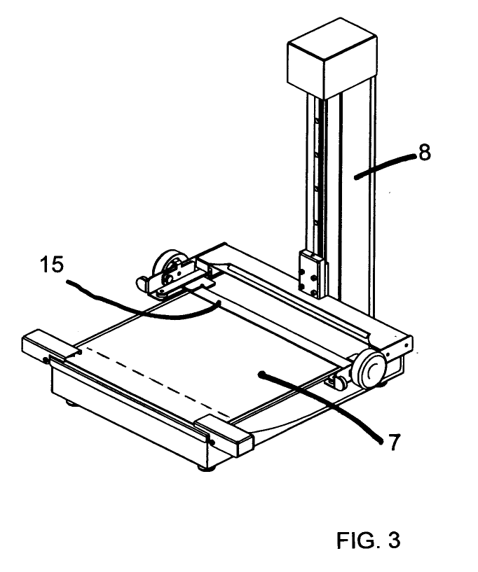

FIG. 3, for its part shows the placing of the first board sheet in the device;

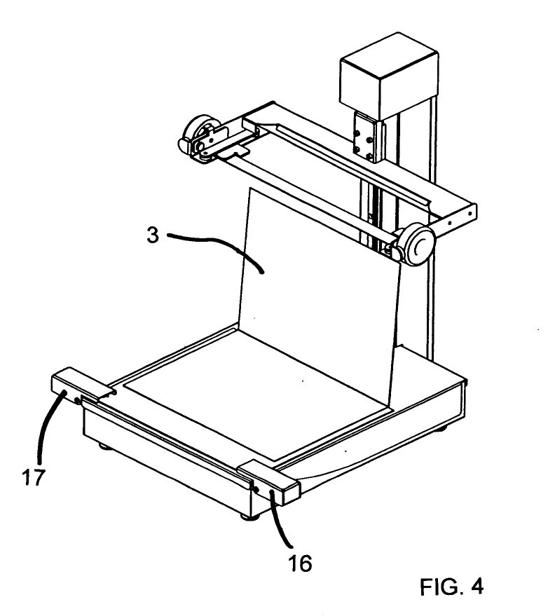

FIG. 4 shows one stage in the placing of a photograph sheet in the device; and

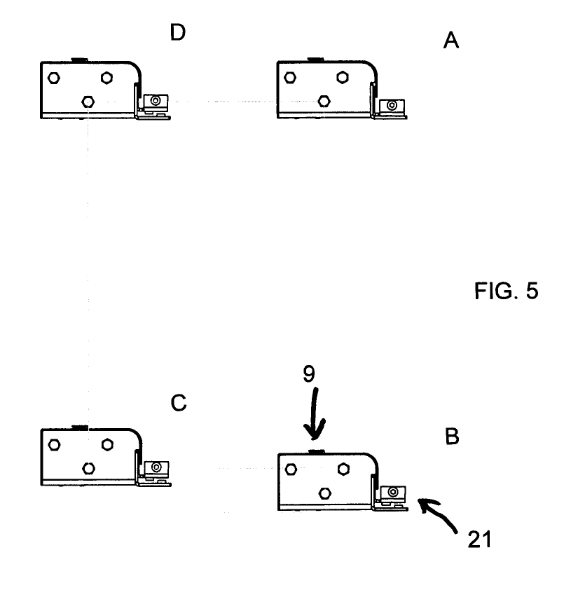

FIG. 5 shows an envisaged motorized alternative for the device.

As stated, FIG. 1 shows the end result of the procedure according to the invention. Thus the completed, but possibly unfinished album 1 is formed of several photograph sheets 3, which are located as shown folded and separated from each other by board sheets 4, and with board sheets 2, 5 glued to them and enclosing them on both sides.

Though manual gluing is possible, it is obviously easier to use divider and cover board sheets 2, 4, 5, in which there is an adhesive surface under a protective sheet.

FIG. 2 shows a general view of a manual device according to the device. Thus, the device 6 is formed of a worktable 7, which is essential horizontal and forms the horizontal body of the device. A vertical frame 8, which acts as a support for a carrier 9, which moves vertically up and down along guides 10, is attached to the edge of the table.

The carrier 9 has essentially a wide U shape, with an auxiliary carrier, which is formed by drive wheels 11 and 12 and slider pieces 13, 14 connected to them, with between them a strip 15 made particularly of metal but also possibly of plastic, attached to the outer ends of the arms of the U.

In the device according to the invention, magnets are utilized as follows. In order to hold the sheets in place, magnetic catches 16 and 17 are situated at the corners of the table 7. These catches are intended to hold the sheets, mainly the first cover sheet, on the table, in such a way that the catch is rotated around its axis in such a way that the magnetic part shown like a disc in connection with the catch 17 clicks into the horizontal position and locks onto the table. If there is material in between, the magnet will hold it in position. The attraction of the magnetic is sufficient for the stated purpose, but not, however, great enough to make rotating the catches back to the open position an operation demanding too much force.

Another place utilizing magnets in the device according to the invention is the magnets in the carrier structure, marked with the reference numbers 18 and 19. The drive wheels 11, 12, which are used as an aid to move the totality backwards and then forwards in the manner shown by the arrow, are made from a non-magnetic material, but at the desired stopping point a piece of magnetic material is embedded in the wheels 11 and 12, though this is not separately marked in the figure. The wheels 11 and 12 are intended to stop automatically in the front position, because the magnets 18 and 19 will strongly attract the pieces of magnetic material and hold the moving parts 11-15 of the carrier 9 stopped in their forward-most position.

As FIG. 1 clearly shows, the cover sheets 2 and 5 are larger than the other sheets and the divider sheets 4 are slightly larger than the photograph sheets 3. The size of particularly the first cover sheet to be positioned on the table 7 is important, as this creates a base sheet, which easily remains firmly in place, the said magnetic catches being used to retain it. The outer parts of the cover sheets 2 and 5, in which area the retention takes place, are not glued and thus easy to handle.

The method according to the invention will also become clearly apparent in connection with the operation of the device according to the invention.

The operations required for making a photograph album are as follows. Here reference is made to different figures, the initial situation being first explained with reference to FIG. 2. From the situation shown in FIG. 2, a start is made by lowering the carrier 9 to the lower position, so that the moving parts 11-15 in the front of the carrier are essentially against the table 7. The moving parts 11-15 are pulled forward, when they lock into place thanks to the magnets 18 and 19.

The protective film, which protects the adhesive surface, is removed from the first of the cover sheets 5. This open adhesive surface, which extends over the entire area except for the front edge marked by the broken line in FIG. 3, faces upwards. The sheet 5 is positioned against shoulders 20 and, after precise positioning, the magnetic catches 16 and 17 are clicked shut to hold the sheet precisely in place during the entire operation. The broken line in FIG. 3 can also mark a perforation in the protective sheet. In that case, the entire surface can be covered in adhesive, but the protective film is only torn off the main part, the edge of the sheet remaining covered by the film, allowing easy handling.

The moving parts 11-15 of the carrier are now pushed away from the user to the position shown in FIG. 3, so that the strip 15 moves away from the sheet 5. The carrier 9 is moved vertically to a suitable height, where it remains. A folded photograph sheet is taken and threaded around the strip 15, the fold in the sheet being set precisely against the back edge of the strip 15, holding the sheet slightly tensioned towards the user. The carrier with the photograph sheet is lowered onto the table and the sheet pressed by hand onto the adhesive surface of the sheet 5.

Next comes the situation shown in FIG. 4. The carrier 9 is raised, so that the strip 15 rises freely from between the folded photograph sheet. The raised half of the sheet is pressed back down. The carrier is lowered on top of the photograph sheet that has just been secured. Obviously, the unglued part of the sheet can equally well be raised manually, to facilitate the movements of the device.

In the next stage, the sheet protecting the glue is removed from the other side of the divider sheet and again positioned utilizing the shoulders and glued, to the upper surface of the photograph sheet. The protective film is now removed of the side of the divider sheet now facing upwards, exposing the adhesive surface. The next photograph sheet is glued to this as described above and the operations are continued until the desired number of photograph sheets have been glued, after which the upper cover sheet 2 is glued in place.

In the embodiment described, the strip 15 repeatedly touches the surface containing adhesive. Similarly, the area of the shoulders is also in direct contact with the adhesive surface when the divider sheet 4 is set in place. It is therefore important to suitably prevent the adhesive adhering strongly to the said surfaces. This can be done easily using a suitable surface treatment. Only a small edge area of the sheet glued in place remains weakly attached to the said surfaces, which allows the positioning means to be detached easily and moved away from the location of the glued product part, according to the principle of the invention.

The package is removed from the device and final cutting takes place to clean the edges. As FIG. 1 shows, the sheet sizes are such that in this stage the outer edges of the divider sheets are glued together, due to their adhesive surfaces. Thus at this stage the album is a very solid package, which cutting then shapes to a state, in which the sides can be freely opened. If desired, the actual covers can be glued after this. The adhesive surfaces on the outer surfaces of the cover sheets 2 and 5 are used in that case. The protective films are removed from them and the covers glued in place. If the cover sheets 2 and 5 are used without separate covers, suitable texts or images are printed on these sheets. Of course, there is then reason to cover the spine of the album with a flexible material.

The pages of the previously described album are turned with the aid of the folds of the photograph sheets on the spine side of the album.

Another alternative for positioning the photograph sheets is to use a gap formed by two strips or similar ‘lips’, instead of the strip 15. The said gap is arranged in such a way that the folded edge of a photograph sheet pushed between the said lips stops at the desired positioning point. The lips can be sufficiently tightly against each other that the sheet remains in position without other measures. On the other hand, the lips can also be arranged to close by operating a suitable lever, or, for instance, bring the moving parts 11-15 of the carrier to the forward position causes the lips to clamp onto the sheet to hold it in place.

FIG. 5 shows a motorized version relating to the above alternative. In it, the letters A-D are used as a series of side views marking the movements of the part 9 corresponding to the carrier. In the place marked A, the carrier is up, the lips or jaws 21 having just closed, taking the folded edge of a photograph sheet between them. From here, the carrier takes the sheet down to B, where the jaws open after gluing and the carrier moves to the rear position C, from where it rises again to D and the cycle repeats. If the carrier 9 has shoulders or similar positioning aids for the divider sheets, the carrier is brought empty to position B for positioning.

An additional alternative to the above operations is to use only a certain kind of counter surface against which the sheet's folded edge is pressed, and where the sheet is held by hand during the next stage, i.e. gluing, or at least until gluing has reached a stage in which the sheet no longer moves, thus ensuring the final result.

The aforementioned photograph-sheet retaining mechanism can also easily be automated by an electrically-operated system, which preferably uses the operating device to clamp and transport the sheet between the upper and lower positions. The removal of the sheet can easily be added as an automatic operation to the movement in the extreme positions. In any event, the movements of the sheet carrier include possible forwards-backwards movement, electrically or manually.

Now and then the strip 15 will touch the adhesive surface. For such contacts, the strip can be made of, or treated with a material that scarcely adheres to the adhesive surface, being either permanently non-stick, or requiring repeated treatment at intervals. Various silicon materials are well suited to this purpose. A small adhesion will not prevent the method from being performed smoothly.

The construction described above is only one example of a device according to the invention. Obviously in a production form the technical details or especially the appearance of the device can differ even greatly from the embodiment described. Thus it must be understood that variations are possible, while even so remaining within the protective scope of the inventive idea and accompanying Claims.

For example, as an alternative embodiment the table 7 can be shaped for the first cover sheet, in such a way that the sheet can be placed on the table in only one position, which is automatically correct. A trough-like structure, or raised edges that guide the sheet into place, can be used as such guides.

It should also be noted that, when reference is made above to moving parts 11-15, an analogous structure is one, in which these parts are fixed, but the table moves. The question is thus of the mutual movement of the table and the parts 11-15, with the aid of which the strip with its attachments and the shoulder ensuring positioning, or a similar detent, or other corresponding other parts can be moved out of the way for the following operations.

1. (canceled)

2. (canceled)

3. (canceled)

4. (canceled)

5. A Device (6) for making an album (1), particularly of folded photograph sheets (3), covers (2, 5) and divider sheets (4), which are glued into the form of an album, the device (6) comprising:
a) a horizontal body formed by a worktable (7) that is essentially horizontal;
b) a vertical frame (8) comprising a guide (10);
c) a carrier (9) that is movable vertically up and down along said guide (10);
d) said carrier (9) further including a positioning-means, said positioning means comprising actual positioning elements (11-15, 20) that are movable horizontally backwards and forwards in relation to the carrier (9) and the worktable (7);
and wherein:
e) said positioning-means is configured to:
i) enable positioning of a folded photograph sheet (3) with respect to: a) a first cover (5) or b) a divider sheet (4), which is located on the worktable (7);
ii) enable gluing of said folded photograph sheet (3) at one side of the fold to an adhesive surface of the first cover (5) or of the divider sheet (4) against the worktable (7);
iii) enable positioning of a second cover sheet (2) or of a further divider sheet (5) with respect to the glued folded photograph sheet (3); and
iv) enable gluing of an adhesive surface of said second cover (5) or of said further divider sheet (4) to said folded photograph sheet (3) at the other side of the fold against the worktable.

6. (canceled)

7. The device (6) according to claim 5, wherein the actual positioning elements (11-15, 20) further comprise counter-surfaces, shoulders (20), or similar elements for performing positioning.

8. The Device (6) according to claim 7, wherein the actual positioning elements (11-15, 20) further comprise, in addition to the counter-surfaces, shoulders (20), or similar elements, also a strip-like element (15) for positioning a folded photograph sheet (3) by placing the folded photograph sheet (3) around the strip-like element (15).

9. The device (6) according to claim 1, wherein the positioning means further comprises lips or jaws (21) for clamping a folded photograph sheet (3) between them.

10. A device (6) according to claim 1, wherein the vertical frame (8) is a tower-like construction located at one edge of the worktable (7).

11. The device (6) according to claim 1, wherein the vertical frame (8) is adapted to support the carrier (9) proximate a central portion of said carrier (9).

12. The device (6) according to claim 1, further comprising first and second magnetic catches (16, 17) situated at first and second corners of the table (7), and configured for holding said first cover sheet (5) in place against the worktable (7).

13. The device (6) according to claim 1, wherein:
the carrier (9) has essentially a U shape; and
wherein the device (6) further comprises an auxiliary carrier that is formed by first and second drive wheels (11, 12) and first and second slider pieces (13, 14) connected to the first and second drive wheels (11, 12) respectively, and further including a strip (15) extending between the first and second drive wheels (11, 12) and the first and second slider pieces (13, 14), wherein said slider piece (15) is attached to first and second outer ends of first and second arms that form the U shaped carrier (9).

14. The device (6) according to claim 13, wherein:
the device (6) further comprises magnets (18, 19) attached to said first and second outer ends of said first and second arms that form the U shaped carrier (9);
and wherein said drive wheels (11, 12) are configured to move the positioning means backwards and forwards in relation to the carrier (9), and wherein said drive wheels (11, 12) are made from a non-magnetic material and include, at a desired stopping point, a piece of magnetic material embedded in the drive wheels (11, 12), so that the magnets (18, 19) attract the pieces of magnetic material in the drive wheels (11, 12) to stop the drive wheels (11, 12) automatically in a front position and thus hold moving parts of the carrier (9) stopped in said front position.

15. A package (1) for making an album, comprising:
two cover sheets (2, 5);
a plurality of folded photograph sheets (3) between the cover sheets (2, 5); and
a plurality of divider sheets (4), each of said plurality of divider sheets located between each of said plurality of folded photograph sheets (3); and
wherein:
the outermost photograph sheets (3) have been glued from one side to an inner side of a respective cover sheet (2, 5) and from the other side of the fold to a divider sheet (4); and
the inner photograph sheets (3) have been glued from both sides of the fold to respective divider sheets (4);
and wherein:
the cover sheets (2, 5) are larger than the folded photograph sheets (3) and the divider sheets (4) for easier handling.

16. The package according to claim 15, wherein each of said two cover sheets (2, 5) comprises a protective film which protects an adhesive surface disposed on at least one side of said two cover sheets (2, 5).

17. The package according to claim 16, wherein said adhesive surface extends over the entire area of said cover sheet (2, 5) except for a front edge portion.

18. A method for making an album using the device according to claim 1, wherein said album is make from a package, said package comprising:
two cover sheets (2, 5);
a plurality of folded photograph sheets (3) between the cover sheets (2, 5); and
a plurality of divider sheets (4), each of said plurality of divider sheets located between each of said plurality of folded photograph sheets (3); and
wherein:
the outermost photograph sheets (3) have been glued from one side to an inner side of a respective cover sheet (2, 5) and from the other side of the fold to a divider sheet (4); and
the inner photograph sheets (3) have been glued from both sides of the fold to respective divider sheets (4);
and wherein:
the cover sheets (2, 5) are larger than the folded photograph sheets (3) and the divider sheets (4) for easier handling.

19. The package according to claim 18, wherein each of said two cover sheets (2, 5) comprises a protective film which protects an adhesive surface disposed on at least one side of said two cover sheets (2, 5).

20. The package according to claim 19, wherein said adhesive surface extends over the entire area of said cover sheet (2, 5) except for a front edge portion.
